(19) United States
(12) Patent Application Publication
(10) Pub. No.: US 2010/0246173 A1
(43) Pub. Date: Sep. 30, 2010

(54) ILLUMINATION DEVICE WITH LIGHT DIFFUSION PLATE

(75) Inventors: AN-CHI WEI, Chu-Nan (TW); CHIH-MING LAI, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/612,019

(22) Filed: Nov. 4, 2009

(30) Foreign Application Priority Data
Mar. 26, 2009 (CN) 200910301145.4

(51) Int. Cl. F21V 11/00; F21V 5/00

(52) U.S. Cl. 362/235; 362/311.02; 362/311.05; 362/311.03; 362/311.06

(57) ABSTRACT

An exemplary illumination device includes a solid-state light source and a light diffusion plate. The solid-state light source is configured for generating light, and the solid-state light source defines a central axis. The light diffusion plate is arranged generally adjacent to the solid-state light source. The plate includes an incident surface and an output surface at opposite sides thereof. At least one of the incident surface and the output surface has parallel micro-structures each having a length parallel to a first reference axis. The micro-structures are arranged in two groups at opposite sides of the central axis, and the micro-structures of the two groups are symmetrical relative to each other across the central axis. The first micro-structures are configured for increasing a radiating range of the light entering the plate along respective opposite directions of a second reference axis substantially perpendicular to the first reference axis.

### BACKGROUND

1. Technical Field

The disclosure generally relates to illumination devices, and particularly to an illumination device having a light diffusion plate.

2. Description of Related Art

Light emitting diodes (LEDs) have recently been extensively used as light sources due to their high luminous efficiency, low power consumption and long lifespan. FIG. 7 is a diagram illustrating a Lambertian light intensity distribution of a conventional LED. The Full Width at Half Maximum (FWHM) of the LED is in a range from about 0 degrees to about 60 degrees, and also in a range from about 300 degrees to about 360 degrees. That is, the FWHM of the LED is about 120 degrees. Therefore, the LED has a limited radiating range of output light. Thus the range of applications suitable for the LED is limited.

Accordingly, what is needed is an illumination device that overcomes the described limitations.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of part of an illumination device according to a first embodiment, as seen from a position in front of the illumination device, the illumination device including a generally cuboid-shaped plate.

FIG. 2 is a diagram illustrating light intensity distribution of the illumination device of FIG. 1.

FIG. 3 is a schematic view of part of an illumination device according to a second embodiment, as seen from a position in front of the illumination device, the illumination device including a generally cuboid-shaped plate.

FIG. 4 is a schematic view of an illumination device according to a third embodiment, as seen from a position in front of the illumination device, the illumination device including an arc-shaped plate.

FIG. 5 is an isometric view of an illumination device according to a fourth embodiment, the illumination device including a generally cuboid-shaped plate.

FIG. 6 is a diagram illustrating light intensity distribution of the illumination device of FIG. 5.

FIG. 7 is a diagram illustrating light intensity distribution of a conventional LED.

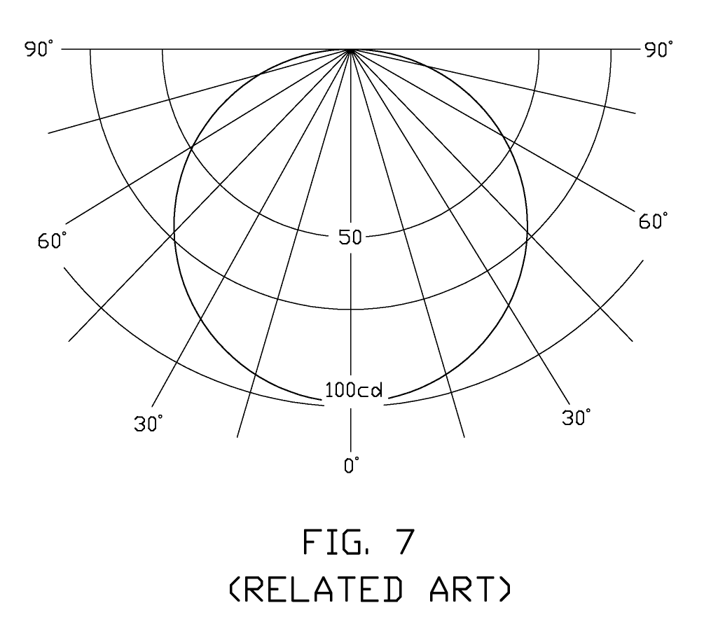

### DETAILED DESCRIPTION

Embodiments will now be described in detail below, with reference to the drawings.

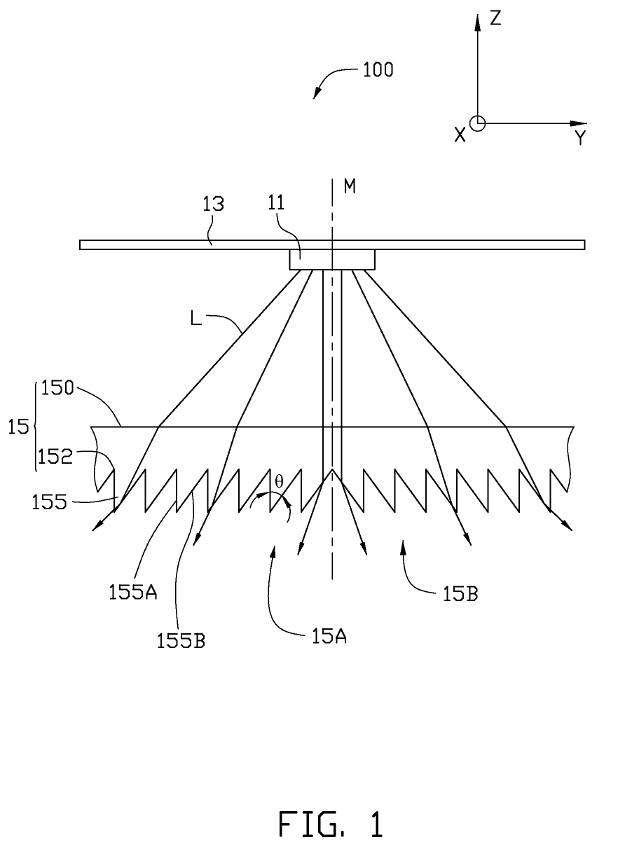

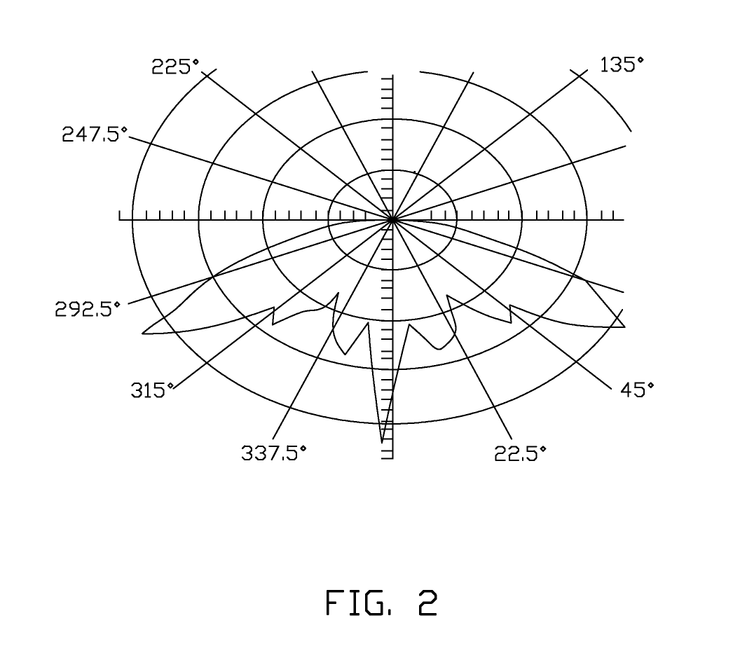

Referring to FIGS. 1 and 2, an illumination device 100, according to a first embodiment, is shown. The illumination device 100 includes a solid-state light source 11 and a light diffusion plate 15.

The solid-state light source 11 may for example be an LED or an LED chip. In this embodiment, the solid-state light source 11 is an LED providing a Lambertian light intensity distribution. The solid-state light source 11 defines a central axis M, which passes through the plate 15. The central axis M is parallel to a defined Z-axis, as shown in FIG. 1. The illumination device 100 may further include a substrate 13; thereby, the solid-state light source 11 can be secured on the substrate 13. The substrate 13 may for example be a circuit board.

In the illustrated embodiment, the plate 15 has a generally cuboid shape. The plate includes an incident surface 150 and an output surface 152 at opposite sides thereof. The incident surface 150 is a planar surface, and the incident surface 150 and the output surface 152 are substantially parallel with one another. The incident surface 150 faces the solid-state light source 11. The plate 15 can be made of transparent or light-pervious material, such as glass, resin, silicone, epoxy, polyethylene terephthalate, polymethyl methacrylate or polycarbonate. Alternatively, the plate 15 can be made of other suitable kinds of transparent or light-pervious material.

The plate 15 defines a plurality of micro-structures 155 thereon. Each of the micro-structures 155 extends parallel to an X-axis. The X-axis is perpendicular to the Z-axis. All the micro-structures 155 are parallel with one another, and adjoin one another. In the illustrated embodiment, each of the micro-structures 155 is an elongate protrusion, which extends outwardly from the output surface 152 of the plate 15. In one embodiment, the micro-structures 155 can be provided by defining a plurality of grooves in the output surface 152.

Each of the micro-structures 155 may have a triangular, trapezoidal, or hemicycle-shaped cross section taken in the YZ-plane. In the illustrated embodiment, such cross section of each micro-structure 155 is a triangle. A vertex angle θ of the triangle is preferably in a range from about 20 degrees to about 70 degrees. Each micro-structure 155 includes a first surface 155A and a second surface 155B. The second surface 155B adjoins the first surface 155A. The first surface 155A is located at a side of the micro-structure 155 farther away from the central axis M. The second surface 155B is located at the other side of the micro-structure 155 nearer to the central axis M. Preferably, the first surface 155A is parallel to the XZ-plane. In the illustrated embodiment, the second surface 155B of each micro-structure 155 adjoins the first surface 155A of the neighboring micro-structure 155. In alternative embodiments, the second surface 155B of each micro-structure 155 can be adjacent to the first surface 155A of the neighboring micro-structure 155 but not adjoin such first surface 155A.

The micro-structures 155 are arranged in two groups, which are symmetrically opposite to each other across the central axis M. Thereby, two arrays of micro-structures 15A, 15B are defined at the two sides of the central axis M. The micro-structures 155 of the two arrays of micro-structures 15A, 15B are symmetrical relative to each other across the central axis M.

In operation, when electric current is applied to the solid-state light source 11, the solid-state light source 11 emits light L. The light L enters the plate 15 through the incident surface 150. The light L then passes through the plate 15 to the micro-structures 155. The micro-structures 155 refract or totally reflect the light L, and at least some of the totally reflected light is recycled in the plate to eventually be refracted by the micro-structures 155. Thereby, the first and second surfaces 155A, 155B increase a radiating range of the refracted light that exits the micro-structures 155, the increase being in positive and negative Y-axis directions. Overall, the light L is diffused by the two arrays of micro-structures 15A, 15B to deviate from the central axis M along the positive and negative Y-axis directions. Thus, the radiating range of the output light along the Y-axis directions is increased.

FIG. 2 shows that the FWHM of the illumination device 100 along the Y-axis is about 145 degrees. Thereby, the illumination device 100 may be applied in conditions where a large radiating range is needed, such as a dance stage.

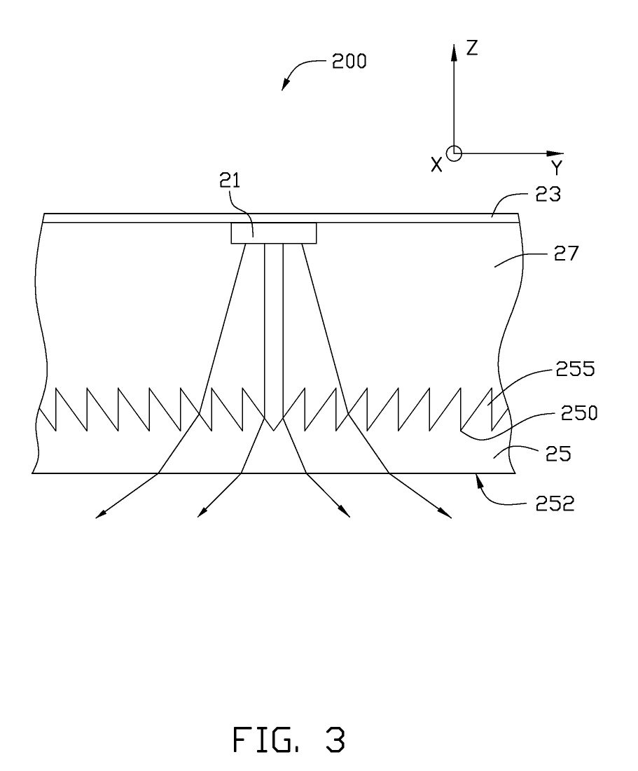

Referring to FIG. 3, an illumination device 200, according to a second embodiment, is shown. The illumination device 200 includes a solid-state light source 21, a substrate 23, and a light diffusion plate 25. The plate 25 includes an incident surface 250 and an output surface 252. The illumination device 200 is similar in principle to the illumination device 100 of the first embodiment. However, in the illumination device 200, a plurality of micro-structures 255 are formed on the incident surface 250, not on the output surface 252. In addition, a bonding layer 27 is provided to interconnect the solid-state light source 21 and the substrate 23 with the plate 25. That is, the bonding layer 27 is positioned between the substrate 23 and the plate 25.

The bonding layer 27 is made of transparent or light-pervious material, such as resin or silicone, with a refractive index less than that of the plate 25. In this embodiment, the solid-state light source 21 can be a light emitting diode chip 21. The light-pervious layer 27 can be used to encapsulate the light emitting diode chip 21.

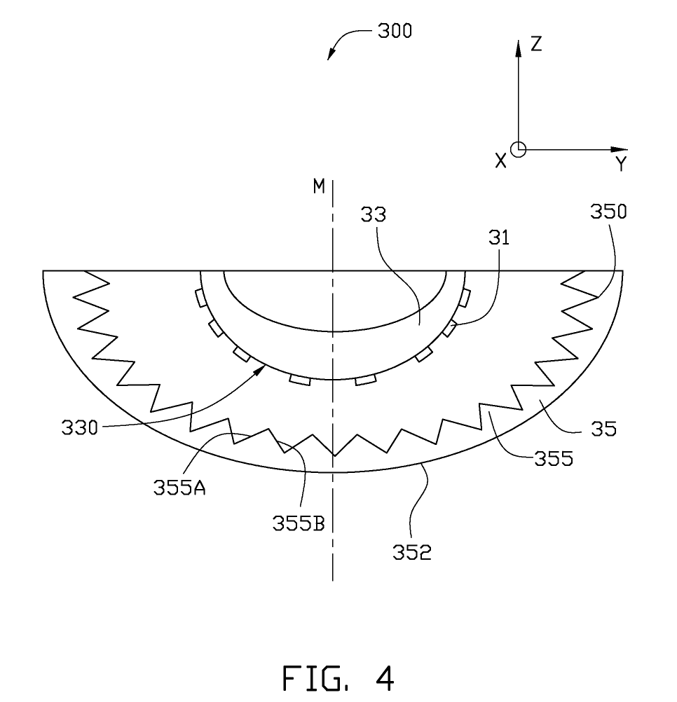

Referring to FIG. 4, an illumination device 300 according to a third embodiment is shown. The illumination device 300 includes a solid-state lighting member (not labeled), a substrate 33, and a light diffusion plate 35. The plate 35 includes an incident surface 350 and an output surface 352 at opposite sides thereof. A plurality of micro-structures 355 are formed on the incident surface 350. Each micro-structure 355 includes a first surface 355A and a second surface 355B. The illumination device 300 differs from the illumination device 200 of the second embodiment in that the plate 35 and the substrate 33 each have an arc-shaped profile. In addition, the solid-state lighting member includes a plurality of LEDs 31.

The incident surface 350 is generally a concave surface. The output surface 352 is a convex surface. The substrate 33 includes a convex surface 330 facing the incident surface 350. The LEDs 31 are distributed on and secured to the convex surface 330. The illumination device with the arrangement of the LEDs 31 on the convex surface 330 achieves a larger radiating range. In this embodiment, the substrate 33 may be made of metallic material with high thermal conductivity, such as copper, aluminum, aluminum-copper alloy, or another suitable type of metallic material. Thereby, heat generated from the LEDs 31 can be efficiently transferred to the substrate 33 and thence dissipated to ambient air. It is noted that, because the micro-structures 355 are formed on the concave incident surface 350, in general, the first surfaces 355A and the second surfaces 355B are not parallel to the XZ-plane.

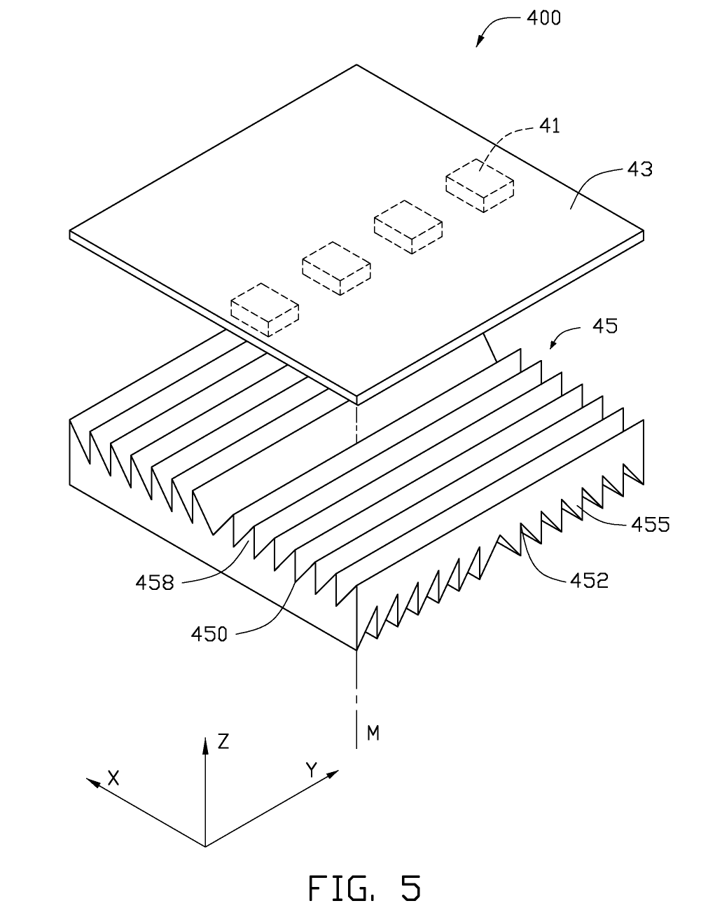

FIG. 5 illustrates an illumination device 400, according to a fourth embodiment. The illumination device 400 is similar to the illumination device 100 of the first embodiment, and includes a solid-state lighting member (not labeled), a substrate 43, and a light diffusion plate 45. The plate 45 includes an incident surface 450 and an output surface 452. A plurality of elongate first micro-structures 455 are formed on the output surface 452. Each of the first micro-structures 455 extends parallel to an X-axis. The illumination device 400 differs from the illumination device 100 in that the plate 45 further has a plurality of second micro-structures 458 formed on the incident surface 450. Each of the second micro-structures 458 extends parallel to a Y-axis. In addition, the solid-state lighting member includes a plurality of LEDs 41 arranged on the substrate 43 in a line parallel to the Y-axis.

The shape and the arrangement of the second micro-structures 458 formed on the incident surface 450 are similar to those of the first micro-structures 455 formed on the output surface 452, except that the second micro-structures 458 each extend along the Y-axis direction, whereas the first micro-structures 455 each extend along the X-axis direction. That is, each of the second micro-structures 458 is arranged perpendicular to each of the first micro-structures 455.

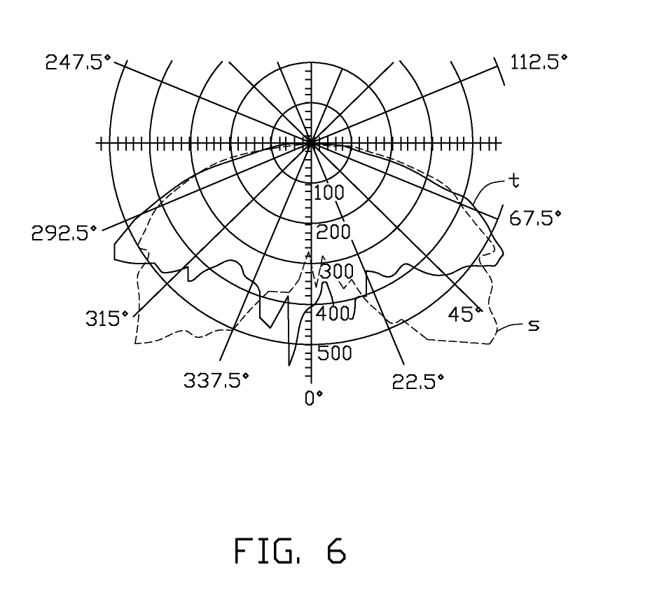

The first micro-structures 455 increase a radiating range of the output light along positive and negative Y-axis directions. The second micro-structures 458 increase the radiating range of the output light along positive and negative X-axis directions. FIG. 6 shows that the FWHM of the illumination device 400 along the X-axis is about 150 degrees (as shown by line s), and that the FWHM of the illumination device 400 along the Y-axis is also about 150 degrees (as shown by line t). That is, the radiating range along the X-axis directions as well as the Y-axis directions is increased.

It can be understood that the above-described embodiments are intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. An illumination device comprising:
a solid-state light source configured for generating light, the solid-state light source defining a central axis;
a light diffusion plate arranged generally adjacent to the solid-state light source, the plate comprising an incident surface and an output surface at opposite sides thereof, the incident surface positioned for receiving the light from the solid-state light source, and the output surface being for emission of the light to the outside of the illumination device, at least one of the incident surface and the output surface having a plurality of parallel first micro-structures each having a length parallel to a first reference axis, the first micro-structures being arranged in two groups at opposite sides of the central axis, the first micro-structures of the two groups being symmetrical relative to each other across the central axis, and the first micro-structures configured for increasing a radiating range of the light entering the plate, the increase of one of the groups of first micro-structures being along one direction of a second reference axis, the increase of the other group of first micro-structures being along an opposite direction of the second reference axis, the second reference axis being substantially perpendicular to the first reference axis.

2. The illumination device of claim 1, wherein the incident surface and the output surface are substantially parallel with each other.

3. The illumination device of claim 2, wherein one of the incident surface and the output surface has the first micro-structures formed thereon, and the other of the incident surface and the output surface has a plurality of second micro-structures formed thereon, each of the second micro-structures has a length parallel to the second reference axis, and the second micro-structures are configured for increasing a radiating range of the light entering into the plate, such increase being along respective opposite directions of the first reference axis.

4. The illumination device of claim 3, wherein the second micro-structures are arranged in two groups at opposite sides of the central axis, the second micro-structures of the two groups being symmetrical relative to each other across the central axis.

5. The illumination device of claim 1, wherein the solid-state light source comprises at least one item selected from the group consisting of a light emitting diode and a light emitting diode chip.

6. The illumination device of claim 1, wherein a cross section of each first micro-structure taken in a plane cooperatively defined by the central axis of the solid-state light source and the second reference axis is triangular, and a vertex angle of the triangle is in a range from about 20 degrees to about 70 degrees.

7. The illumination device of claim 6, wherein each first micro-structure comprises a first surface and a second surface adjacent to the first surface, the first surface is located at a side of the first micro-structure farther away from the central axis of the solid-state light source, the second surface is located at the other side of the first micro-structure nearer to the central axis of the solid-state light source, and the first surface is substantially parallel to a plane cooperatively defined by the central axis of the solid-state light source and the first reference axis.

8. The illumination device of claim 1, wherein a cross section of each first micro-structure taken in a plane cooperatively defined by the central axis of the solid-state light source and the second reference axis is one of hemicycle-shaped and trapezoid-shaped.

9. The illumination device of claim 1, further comprising a light-pervious bonding layer, the plate being coupled to the solid-state light source via the bonding layer.

10. The illumination device of claim 9, wherein a refractive index of the bonding layer is less than that of the plate.

11. The illumination device of claim 9, wherein the bonding layer is made of one of resin and silicone.

12. The illumination device of claim 1, wherein the plate is made of material selected the group consisting of glass, resin, silicone, epoxy, polyethylene terephthalate, polymethyl methacrylate and polycarbonate.

13. The illumination device of claim 1, further comprising a substrate, the solid-state light source being secured on the substrate.

14. The illumination device of claim 13, wherein the substrate comprises a circuit board.

15. The illumination device of claim 13, wherein the incident surface is a concave surface, the output surface is a convex surface, and the substrate comprises a convex surface facing the incident surface.

16. The illumination device of claim 15, wherein the substrate is made of metallic material.

17. The illumination device of claim 16, wherein the metallic material comprises one of aluminum, copper and aluminum-copper alloy.

18. An illumination device comprising:
a substrate having a convex surface;
a plurality of solid-state light sources secured on the convex surface, the plurality of solid-state light sources defining a central axis;
a light diffusion plate arranged generally adjacent to the convex surface of the substrate, the plate comprising a concave incident surface and a convex output surface, the concave incident surface facing the convex surface of the substrate for receiving light from the solid-state light sources, and the convex output surface being for emission of the light to the outside of the illumination device, at least one of the concave incident surface and the convex output surface having a plurality of parallel micro-structures each having a length parallel to a first reference axis, the micro-structures being arranged in two groups at opposite sides of the central axis, the micro-structures of the two groups being symmetrical relative to each other across the central axis, and the micro-structures configured for increasing a radiating range of the light entering the plate, the increase of one of the groups of micro-structures being along one direction of a second reference axis, the increase of the other group of micro-structures being along an opposite direction of the second reference axis, the second reference axis being substantially perpendicular to the first reference axis.

19. The illumination device of claim 18, wherein the substrate is made of metallic material.

20. The illumination device of claim 19, wherein the metallic material comprises one of aluminum, copper and aluminum-copper alloy.
